(19) United States
(12) Patent Application Publication
(10) Pub. No.: US 2005/0253547 A1
(43) Pub. Date: Nov. 17, 2005

(54) Integrated system for controlling axes of industrial machinery

(76) Inventors: Adriano Cazzavillan, Sovizzo-Vicenza (IT); Dario Zatton, Trissino-Vicenza (IT)

Correspondence Address: HEDMAN & COSTIGAN P.C., 1185 AVENUE OF THE AMERICAS, NEW YORK, NY, 10036, US

(21) Appl. No.: 10/507,966

(22) PCT Filed: Oct. 23, 2002
(86) PCT No.: PCT/EP02/11742

§ 371 Date: Jun. 9, 2005

(30) Foreign Application Priority Data
Mar. 22, 2002 (IT) VI2002A000053

(51) Int. Cl. G05B 19/33

(52) U.S. Cl. 318/575

(57) ABSTRACT

An integrated system for controlling the axes (A1, A2) of industrial machinery, in which said axes (A1, A2) are actuated by actuator means (AN, AZ, AZ1, AZ2), which apply a force so as to determine a displacement in space; at least one motor (M) and at least one transducer (T) suitable for converting physical magnitudes into electrical signals which can be used by a control logic unit (LC) and/or by the aforementioned actuator means, in order to carry out the effect of the motion commands given by the motor (M) to each of said axes (A1, A2). In particular, each motor (M) is connected to at least one interface (DMA1, DMA2) for connection to an actuator device (AML) and said interface (DMA1, DMA2) foresees means suitable for supplying or not supplying energy to the motor (M) according to that which is requested by said actuator device (AMU) and means for the management and selection (LSA) of each axis (A1, A2).

The present invention regards, in general, an integrated system for controlling axes of industrial machinery.

More specifically, the invention refers to a system for controlling the force applied by determined mechanisms (axes), actuated by motors or by pistons, on mechanical apparatuses (loads) which make up a job; the displacement of the load in the space is defined as trajectory, whereas the way in which the trajectory is carried out depends upon the law of motion which is applied to the load.

In the realisation of machinery for industrial production it is known and usual to use electric motors which can be utilised as elements for controlling the force applied onto mechanical apparatuses which carry out a job.

The current technique provides designers with a wide range of electric motors of different constructive types, each with technical and economic characteristics which make it more or less suitable for being used in determined applications rather than in others.

The greater known and used types of such motors comprise synchronous, asynchronous, DC and stepper motors.

The name axis is commonly used to indicate the group consisting of the electric motor, the electromechanical actuator (relays, remote control switches, electrovalves, servomechanisms, electrical actuators, etc.) and the possible speed and/or position transducers used as feedback elements, in order to suitably modulate the force applied to the mechanism.

To regulate such a force in time electrical activators are generally used, which modulate the direction and intensity of the current circulating in the electrical windings of the motor according to predetermined regulation techniques, which are differentiated upon the basis of the constructive type of the motor.

Generally, in a piece of industrial machinery many axes are arranged, each having the task of carrying out a specific work program, which are often equipped with different types of motor.

Some axes, in order to be able to correctly carry out their tasks, must, in certain steps of treatment, be activated simultaneously and are therefore called interlocked axes; other axes, on the other hand, can be actuated independently from each other, according to the treatment step in progress, and are therefore usually known as independent axes.

A further classification of axes is based upon the distinction between axes used to cyclically carry out operations relative to the productive cycle of the machine (productive axes) and axes which, on the other hand, are only used to arrange the machine before starting to carry out the cyclical production sequences (auxiliary or “format-change” axes).

In general, for economic reasons, auxiliary axes are rarely motorised and their regulation on different treatment positions, based upon the type of product to be made, is generally left to the operator who manages the machinery.

Industry, whose current tendency is that of producing only presold articles to reduce stocks of finished products, which cause an economic loss on capital and unused space, finally requires ever more flexible machinery, i.e. capable of quickly adapting to changes in production.

If one also considers other factors which influence the choice of how much to automate machinery, such as production to a certified quality or the increasing workforce cost, one can imagine that the number of motorised and controlled auxiliary axes is destined to increase in the coming years.

Realising machinery with so many controlled axes, however, brings a substantial economic investment which makes this machinery not very accessible to small and medium industry.

One possible method for reducing the cost per axis of a piece of machinery is that of using a technique of electrical connection, known as “multiplexing”, through which a lower number of actuators can be installed than the number of axes to be controlled electromechanically switching the electrical connections from one axis to the next according to the treatment step in progress.

In reality, the possibilities of savings in costs which can be achieved by using a single electrical actuator to control many axes are strongly countered by numerous limitations and drawbacks.

Firstly, such possibilities can only be adopted on axes which must carry out different tasks with the same type of motor.

This limitation restricts the field of application, since precisely the constructive characteristics intrinsic to the type of motor make it more or less suitable for a certain application.

Since it is not currently possible to instantly change the way of operating of an actuator to immediately adapt it to the different constructive types of motor, the conventional technique of “multiplexing” is generally used to control auxiliary axes, given that they can more easily all be equipped with motors of the same type, since they are not obliged to guarantee the high levels of dynamic performance generally required of productive axes.

Moreover, even if the motors and transducers were of the same type, the operating parameters should in any case be different, due to the different working conditions of the axes; usually, this type of performance can only be provided by a more complex control system with respect to that which is currently offered on the market.

Furthermore, the electromechanical switching of the inputs and outputs from one axis to the next is in any case a flawed solution in terms of its greater complexity, lower reliability and greater cost of cabling, because in the system components are added which would not otherwise be needed.

Finally, the technique of “multiplexing” inevitably introduces time loss when the axes are not in use during the switching step from one axis to the next which, at times, have a negative effect on the productivity of the machine.

The conventional techniques used to realise machinery with controlled axes are now established and are described in detail in the rest of the description for greater clarity.

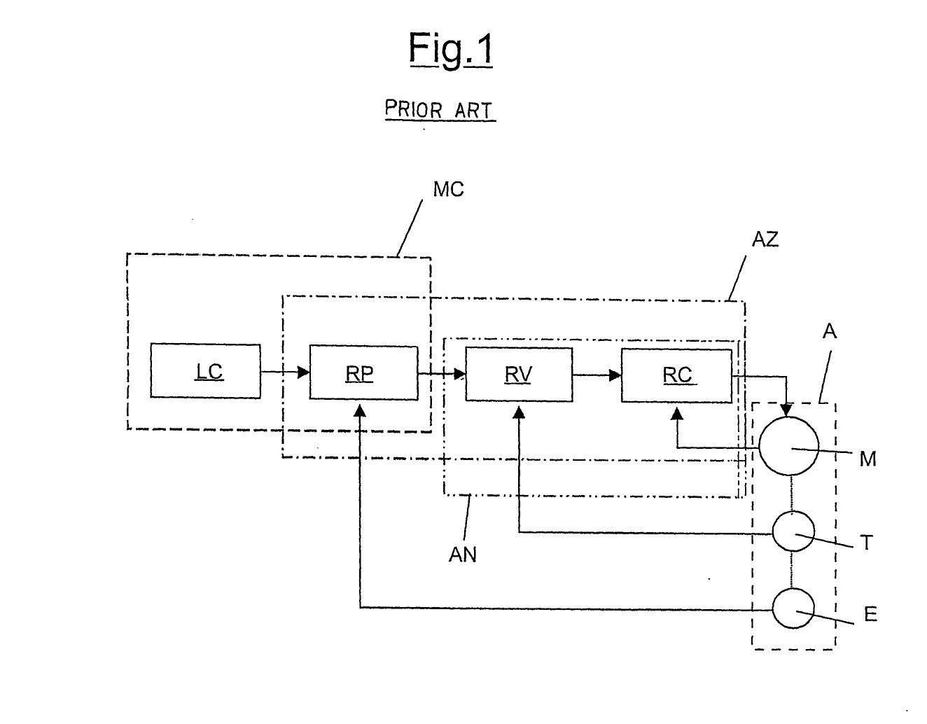

For example, the block diagram shown in FIG. 1 represents a control system of the known type, suitable for obtaining the controlled operation in speed and/or position of an axis A.

In such a case, the electric motor, indicated with M, has the task of physically actuating the movement of the axis A and the mechanical magnitudes of speed and position are formed by the relative transducers indicated with T and E.

The power supply to the motor M is provided by the actuator AN, which usually also realises the regulation in speed, indicated with RV; the regulation of current, on the other hand, is indicated with RC.

The more evolved actuators, defined as “intelligent” (block indicated with AZ in FIG. 1), also include the regulation of position, indicated with RP.

The control logic LC can be realised using a PLC (“Programmable Logic Controller”), an axis controller or “motion controller”, indicated as an example with MC in the figures, or an industrial PC™ (“Personal Computer”).

It usually has the task of controlling and managing all of the devices mounted in the machine and can also take on the functions of position regulator RP if this is not included in the actuator used.

Transducers, actuators and control logic can exchange information between them using both digital and analogue electrical signals.

Recently, systems for exchanging information through various types of serial communication have been introduced, each defined by a specific protocol.

Such a system, much more flexible with respect to the conventional one which directly uses electrical entities, is usually indicated as field bus; with the field bus it is possible to foresee a single communication line between the various devices, which are physically dislocated, even in a distant position.

In this case, each device is characterised by a specific address and intervenes in the communication only when requested.

Inside the communication network there are furthermore “master” devices, which have the role of managing the communication itself, and “slave” devices, which respond to only that which is requested by the masters, so that the information can be transported in an intelligent manner from one device to another through a limited number of electrical conductors.

The greater the number of users and types of information which the field bus must manage, the lower the speed with which the various devices connected to the bus communicate with each other.

This fact limits its use as a channel for exchanging information between the different regulation stages used in controlling the axes.

In a controlled axis, indeed, the intervention and signal-processing times are different and have different critical values in each setting ring; for example, the current coming out from the actuator and circulating upon the motor is one of the most important parameters to control, because both the performance and the reliability of the motor and actuator depend upon it.

For such a reason, it is necessary to measure and regulate such a value in times in the order of a tens of microseconds, these times being, too fast for the most common serial field buses; due to this, the regulation of current is generally managed in the actuator, all the more so since its value can stay in the local environment since it is not of particular interest for the management of the process itself.

However, the case of supervision signals coming from the control logic is different; in this case it concerns general commands, like the starting or stopping of axes, which usually do not require particular urgency and whose response times of a few tens of milliseconds can be effectively managed even using the field bus as means of communication between the various devices.

The control signals of the different stages of regulation of the axes therefore have different users and different speeds which are so different that it is practically impossible to effectively use a single field bus for all of the signals which must be exchanged between them.

In the control of axes two types of serial field buses are generally used: one which is sufficiently flexible but not determining, dedicated to supervision like, for example, “Profibus”, “Canbus”, “Modbus”, “Interbus” or “Ethernet”, and the other which is very fast and determining to transmit the speed and/or position of the axis in real time, like for example “Sercos”.

The physical position of the components indicated in the block diagram of FIG. 1 follows a criterion which has now been well established for years.

In particular, the motor M is, for obvious mechanical reasons, in the immediate vicinity of the actuator and therefore on the machine; in the same location there are the speed and position transducers, T and E respectively, which, finally, are included in a single high-resolution transducer, capable of simultaneously providing information on both of the physical sizes to be measured.

Moreover, the actuator is usually arranged inside the switchboard which closes the governing and control logic LC of the entire apparatus and, therefore, physically far from the motor M and from the transducers T and E; finally, the number of actuators used is usually equal to the number of motors to be controlled.

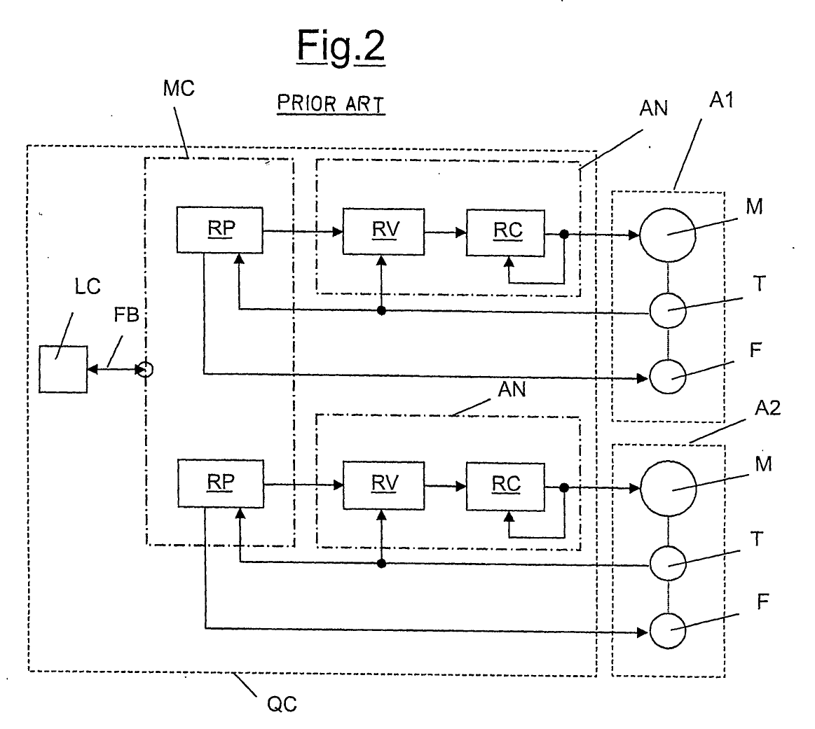

In FIG. 2 the block diagram of another control system of the known type is shown, which foresees an actuator for each axis; in particular, the block diagram of FIG. 2, in which the components which are the same as those of the diagram of FIG. 1 are shown with the same references, comprises a switchboard QC, suitable for controlling two axes A1, A2 through the conventional actuators AN, even if the same diagram can be extended for n axes.

Moreover, each axis A1, A2 comprises, besides a motor M and a speed and position transducer T, a handbrake F. It should be noted that, in the case of FIG. 2, the position regulation is carried out by the motion controller block MC, generally communicating with the control logic LC through a field bus FB.

It is possible, in determined configurations, for the same control logic LC to also take on the functions of the motion controller MC or vice-versa.

If “intelligent” actuators are used, the task of controlling the position is carried out directly by the actuator which, in this case, is almost always equipped with an interface capable of communicating through the field bus FB.

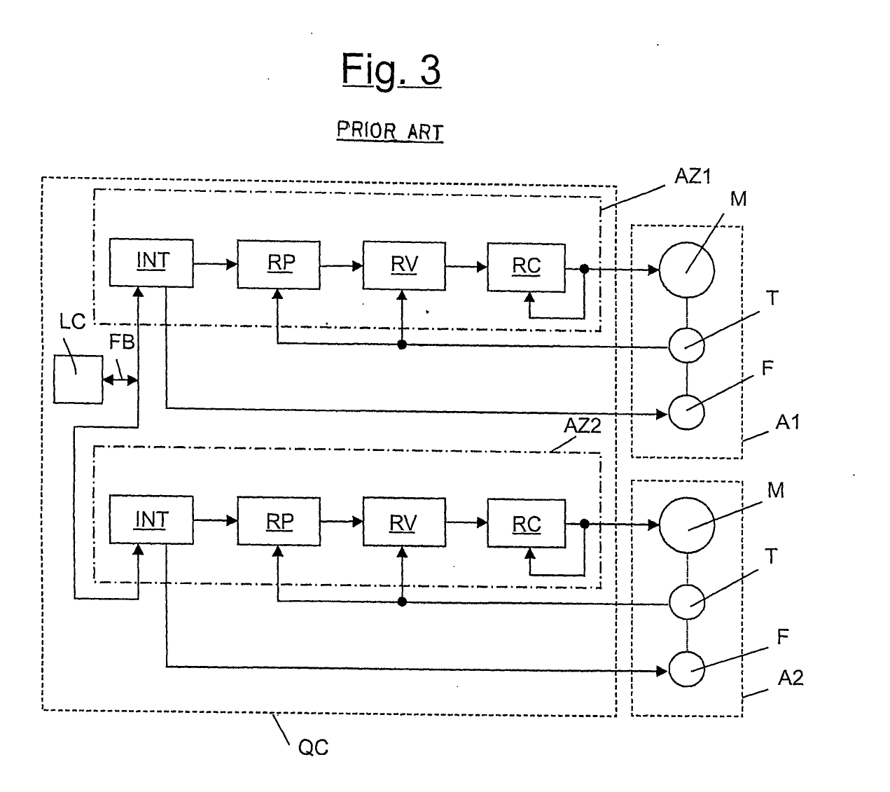

The actuator is thus managed directly by the control logic LC, as illustrated in the block diagram of FIG. 3, which shows a system with two axes A1, A2, with “intelligent” actuators AZ1, AZ2; still in FIG. 3, the interfaces for communication with the field bus FB are indicated with INT and also in this case the components which are the same as those of the diagrams of FIGS. 1 and 2 are shown with the same references.

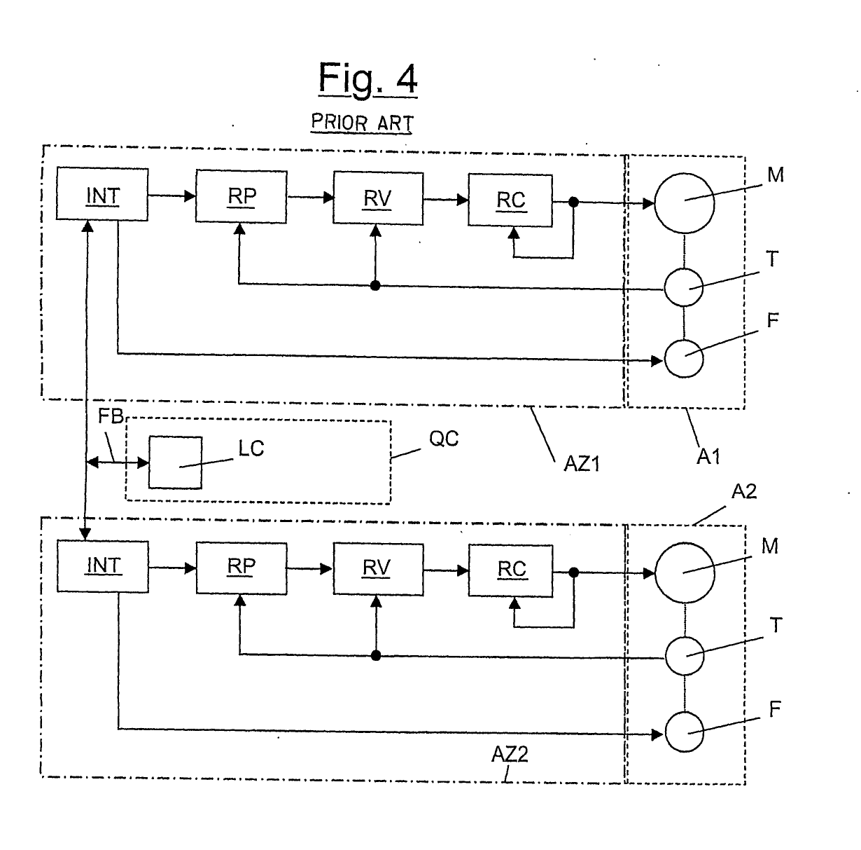

Then there are some configurations (see the block diagram of FIG. 4) according to which the “intelligent” actuator is shown in a group which also comprises the motor itself.

In this case, each “intelligent” actuator AZ1, AZ2 is no longer physically arranged in the switchboard QC, but is on the machine being integral with the motor M, and from the switchboard QC, as well as the signals of the field bus FB, the power supply necessary for the actuator itself leaves.

In any case, this solution also has some drawbacks, both from the thermal point of view, since two heat sources join together, and from the point of view of the mechanical encumbrance, because it increases the total volume.

In the commonly used “multiplexing” technique the actuator is not of the “intelligent” type and the position regulation is usually left to the motion controller MC, in the same way as that which is described in the system of FIG. 2.

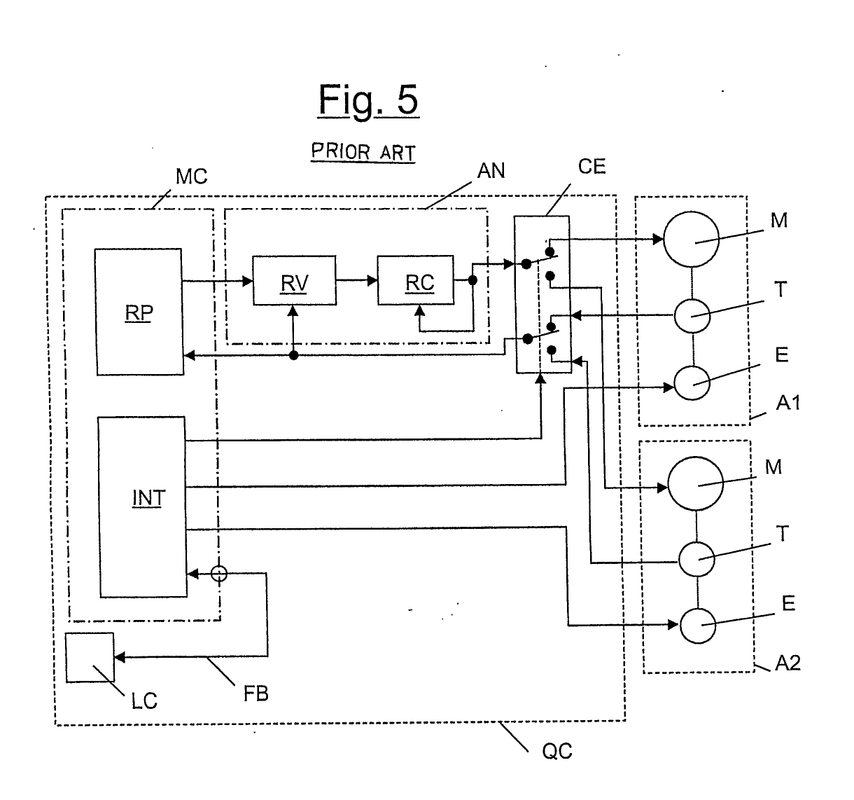

The block diagram of this configuration is shown in detail in FIG. 5, where the components having the same function as those illustrated in the previous figures have the same references.

The output of current of the actuator AN is switched electromechanically, through the block of electromechanical switches CE, on the motor M which one wishes to move.

Generally, the “multiplexing” operation regards not just the outputs of power, but also the inputs for the speed regulator RV and position regulator RP, whereas the selection of the inputs and the outputs INT is left to the motion controller MC or to the control logic LC, in the case in which this also takes on the functions of the motion controller MC.

However, with current “multiplexing” technology it is possible to connect only motors M of the same type to an actuator AN, since on the market there are not electrical actuators which can reconfigure themselves instantly to control, from one occasion to the next, motors of a different constructive type.

Indeed, whilst actuators which, suitably parameterised, can function both in combination with synchronous and asynchronous motors are available on the market, one does not exist which is capable of memorising inside of it all of the diverse parameters necessary for managing the two different ways of operating and of making one or the other active upon the command of an external control logic.

In this type of application absolute transducers are usually used so as not to lose the position reference of the axes A1, A2 during the time intervals in which the transducers are disconnected from the motion controller MC.

The general purpose of the present invention is therefore that of avoiding the drawbacks of the prior art mentioned above and, in particular, that of indicating an integrated system for controlling axes of industrial machinery, which allows the limiting effects linked to conventional solutions to be minimised, so as to make the technique of “multiplexing” of two or more electric axes economically advantageous and reliable.

These and other purposes are achieved by an integrated system for controlling axes of industrial machinery, according to claim 1, to which we refer for the sake of brevity; the further dependent claims contained detailed characteristics of the invention.

Advantageously, the proposed system according to the present invention allows the components which are necessary to the realisation of “multiplexing” to be integrated with the consequent saving in space in the switchboard and a reduction in the times when the actuator is unused during the switching step from one axis to the other.

The adoption of such an architecture also reduces the time necessary for electrical cabling and for the priming of the axes and allows axes equipped with different types of motors (synchronous, asynchronous, DC and stepper) to be controlled with the same actuator, thus making the optimisation of the costs of the motor with respect to the actual technical-applicational requirements of each axis possible.

Such a system also offers the maximum flexibility in configuring similar architectures with each other as a functionality of the productive axes, but which is diversified in the number of automated auxiliary axes since the elements used (actuators, transducers, cables, etc.) can be standardised and therefore can be used in different types of application and independently of the type of motor used.

The possibility of implementing the architecture according to the invention directly on the machine allows the cabling between the various devices to be reduced and allows the electromagnetic emissions on the electric switchboard to be reduced.

Such a configuration also eases the application of auxiliary controlled axes in addition to the basic equipment, both on newly constructed machinery and in updating pre-existing machinery and units.

Finally, if the actuator can be arranged on the machine, the heat energy dissipated during its operation can advantageously be got rid of through the mechanical structure of the machine, given that the typical high thermal inertia of the iron metallic structures combines perfectly with the impulsive operation of the actuator used according to the technique of “multiplexing”.

Further purposes and advantages of the present invention shall become clear from the following description and from the attached drawings, provided purely as a non-limiting example, in which:

FIG. 1 shows a block diagram of a system for controlling the speed and/or position of an axis of industrial machinery, according to the prior art;

FIG. 2 shows a block diagram of a system for controlling two axes through conventional actuators, according to the prior art;

FIG. 3 shows a block diagram of a system for controlling two axes of industrial machinery with an “intelligent” actuator for each axis, according to the prior art;

FIG. 4 shows a block diagram of a control system with an intelligent actuator integrated with the motor for each axis, according to the prior art;

FIG. 5 shows a block diagram of a control system based upon the conventional technique of “multiplexing”, according to the prior art;

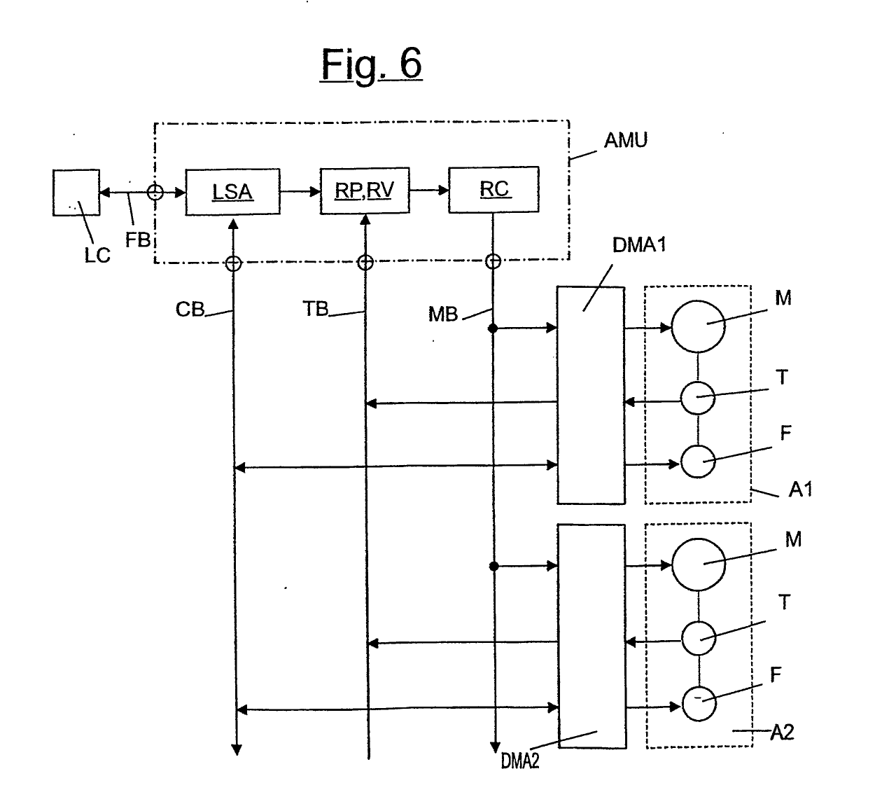

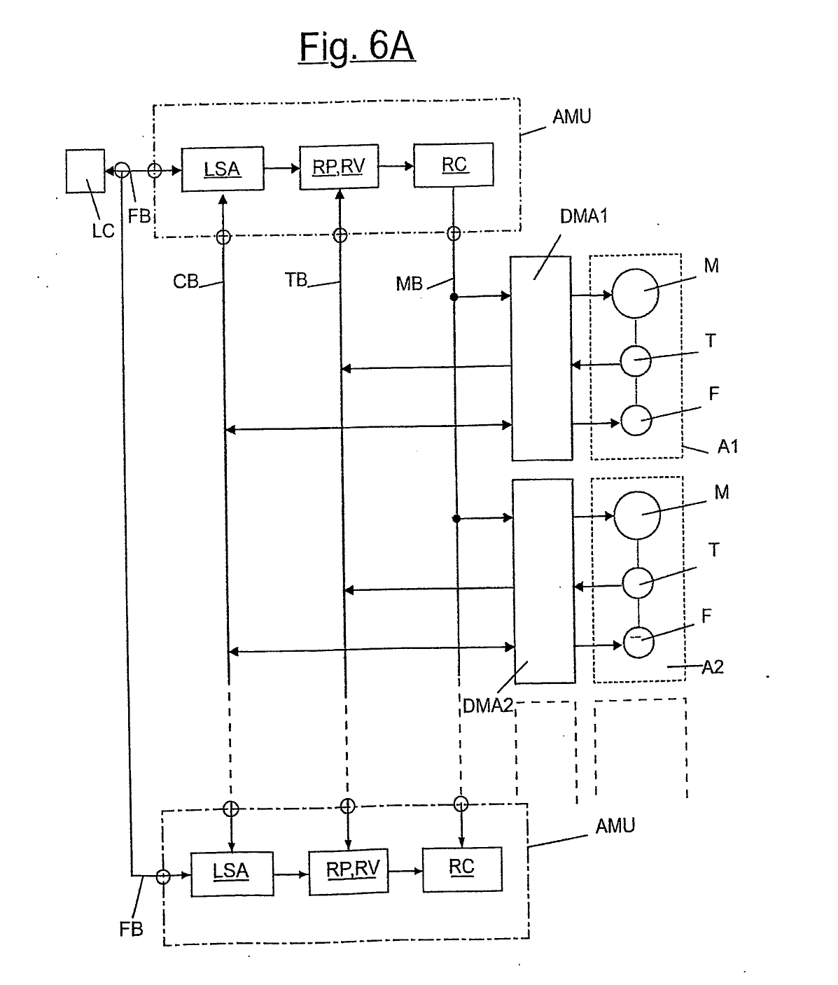

FIG. 6 shows an exemplifying block diagram of an integrated system for controlling the axes of industrial machinery, according to the present invention;

FIG. 6A shows an exemplifying block diagram of a preferred and non-limiting variant of the integrated system for controlling the axes of industrial machinery, according to the invention;

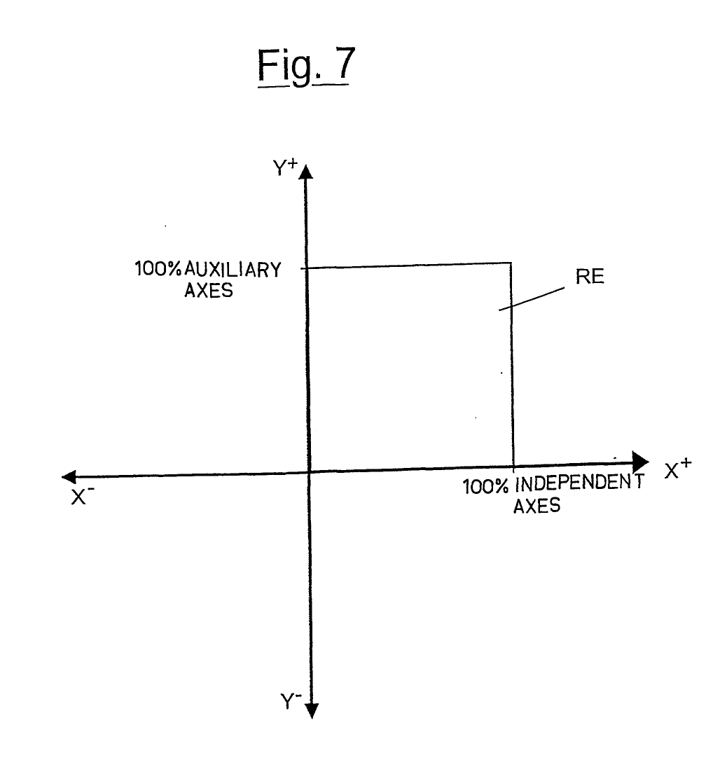

FIG. 7 shows a diagram which displays the conditions of applicability of an axis according to the attributes which it has with respect to the application, according to the present invention;

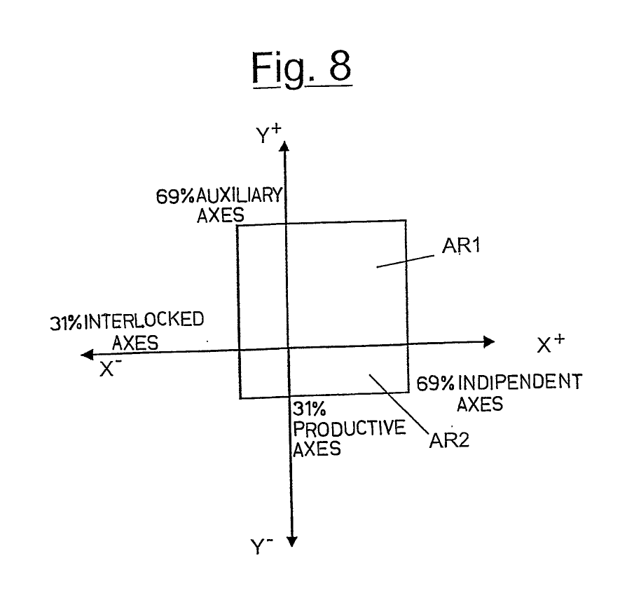

FIG. 8 shows a diagram relative to the overall situation of applicability of the axes, according to an embodiment of the invention;

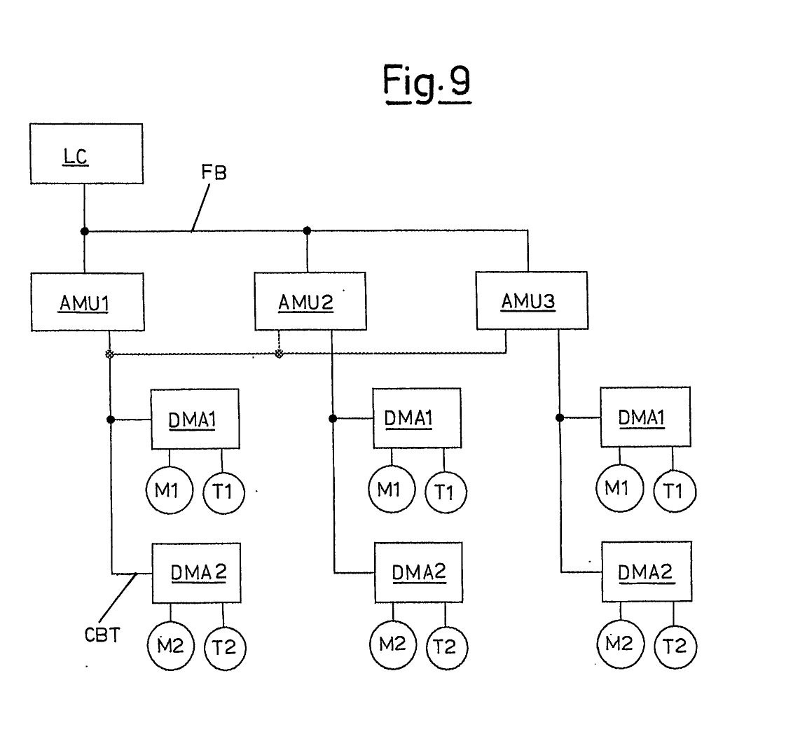

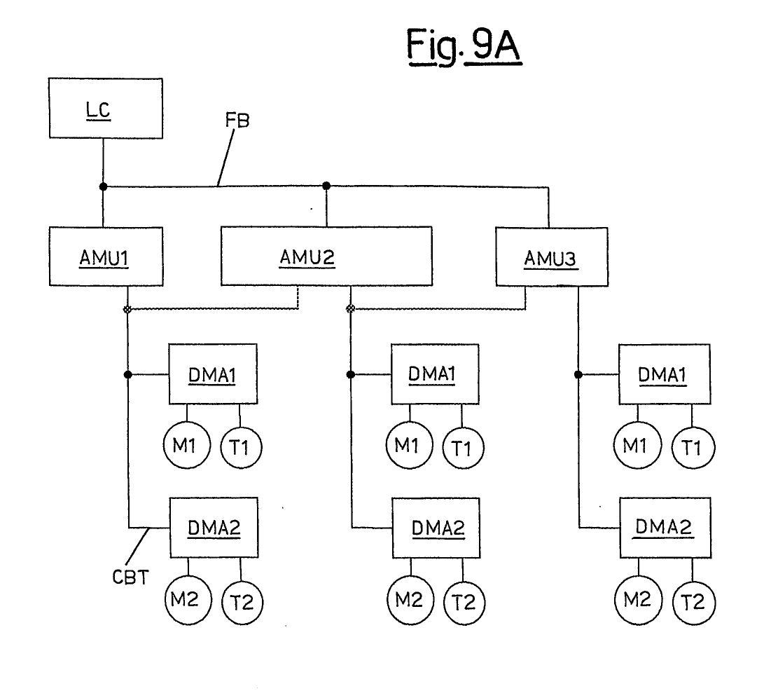

FIG. 9 shows a schematic example of synchronisation of two actuator devices according to the invention of the slave type with an actuator device of the master type with a unified control and transmission bus;

FIG. 9A shows a schematic example of synchronisation of three actuator devices according to the present invention in a cascade of the master/slave type.

With particular reference to the block diagram of the architecture which is object of the present invention, shown in FIG. 6, the control system in question exchanges information and signals through 4 different buses, respectively indicated with FB, CB, TB and MB. Each bus FB, CB, TB, MB has its own speed which adapts to the requirements of the electrical magnitudes or of the exchange signals which transit between the various connected devices, but there is nothing to prevent the functions carried out through 2 or more buses from being able to be integrated in a single bus which in any case manages to guarantee the same performance.

The 4 buses FB, CB, TB, MB are managed by a multiaxis actuator system AMU, which controls the selected motor M in terms of current, speed and position, through the regulators RP, RV, RC.

A “multiplexing” device DMA1, DMA2 associated with each axis A1, A2, respectively, allows many motors M and many transducers T to be connected to a single actuator AMU and, in turn, the actuator AMU is governed by the control logic LC.

The described blocks communicate through the 4 buses defined as FB, CB, TB and MB, each with a specific function.

Firstly, the field bus FB is the interface for the actuator AMU towards any general control logic LC.

This type of bus exchanges information between “intelligent” devices and does not need particular performance in speed and determinism; as an example we can list some of the more common field buses FB which are perfectly suited to this type of application: ModBus, CanBus, ProfiBus, Interbus, Ethernet, etc.

The control bus CB has the purpose of connecting and coordinating the operation of the “multiplexing” devices DMA1, DMA2 of each axis A1, A2 and can consist of any bus, serial or parallel, which manages at least 2 devices DMA1, DMA2.

If the number of axes to connect is high it becomes convenient to use a serial bus which must in any case guarantee a good data exchange speed, with delays in communication no greater than 10 milliseconds, and absolute certainty of operation.

The same bus CB can also be used to supply both the devices DMA1, DMA2 and the possible electromechanical coil of the handbrake F of the selected device DMA1, DMA2.

The bus TB (transducers bus) has the purpose of transmitting the position and speed information from the transducers of the axes A1, A2 to the actuator device AMU.

Since the transducer T is disconnected from the actuator at the end of each operating cycle, the position information must be absolute so as to avoid possible incremental losses of information which have taken place during the time space which passes between one operating cycle and the next, whereas the speed information transmitted must be fast and with sufficient resolution to also allow good regulation of the speed loop of the axis.

The ideal bus TB must therefore allow the transmission of such information in real time and with determinism.

For these requirements of communication a fast digital bus TB can be used, even if they are usually expensive, or else an analogue bus with 2 or more signals can be used, the processing of which in any case allows both the absolute position of the transducer T and the instant speed of the axis A1, A2 to be worked out with good precision.

Only the selected device DMA1, DMA2 shall use the bus TB for transmitting to the actuator device AMU the signals coming from its transducer T, whereas all of the other devices DMA1, DMA2 shall remain disconnected so as not to interfere in the speed and position measurements in progress.

The motor bus MB is a parallel bus with one or more conductors (typically 3) with which energy can be transferred from the actuator AMU to the electric motors M connected to it which can simultaneously belong to all types of known motors, such as DC permanent magnet motors, brushless synchronous motors, asynchronous motors, both single phase and three phase, stepper motors and reluctance motors.

The actuator devices AMU and “multiplexing” devices of the axis DMA1, DMA2 are in fact the core of the architecture object of the present invention; now we would like to offer a brief description of the function carried out by these devices.

Each “multiplexing” device of the axis DMA1, DMA2 constitutes a representational element of the integrated control system according to the invention, since it allows many axes A1, A2 to be connected in sequence to a single actuator device AMU and thus allows the necessary investment to be reduced to the minimum.

The device DMA1, DMA2, through the bus CB, is directly governed by the actuator device AMU and therefore does not require its own on-board logic control intelligence which would inevitably increase its cost and encumbrance.

Its main function is that of connecting or disconnecting the electric motor M of the axis A1, A2 from the motor bus MB.

The activation and deactivation of the motor bus MB can take place in the absence of current circulation thus avoiding the production of undesired transitory phenomenona during the switching and limiting the power dissipated by the components used, which thus can be engineered in sizes such as to be easily installed on the motor M or in the immediate vicinity thereof.

The device DMA1, DMA2, using the control bus CB, can receive and transmit to the actuator AMU both information concerning its operating status (like for example if it is activated or deactivated, if there are alarms in progress, etc.) and information concerning the status of a certain number of inputs and/or outputs which are more or less connected to the operation of the axis A1, A2, such as electrical stops, manual movement commands of the axis, switching on/off the electrovalve or of other automation devices present in the vicinity of the device DMA1, DMA2 and involved in the operation of the machine.

The device DMA1, DMA2 can in any case also carry out auxiliary functions which can be more or less important based upon the type of electric motor used and the relative mechanical application; one of these functions can, for example, be to adapt and/or amplify the signals of the transducer T before connecting them to the bus TB, or else to command the insertion or deactivation of the possible electromechanical handbrake F.

The presence of the transducer T and/or the handbrake F depends upon the application and type of the motor M used; these components can therefore be left out without compromising the correct operation of the integrated control system of the invention.

The actuator device AMU is the heart of the system, since it is the element intended to carry out the actual functions of regulation of the axes; it interfaces with any control logic for industrial automation through the field bus FB, both because this type of serial bus is a standardised means which is sufficiently fast and reliable to place many intelligent devices in communication with each other, and because thus the device AMU can be arranged more easily in field, on the machine, near to the axes which it has to govern, allowing the buses CB, TB and MB to be realised with shorter and therefore less expensive cables.

On the actuator AMU there is a management and selection logic of the axes LSA, capable of effectively completing numerous functions.

First of all it has to communicate through the field bus FB with the control logic LC to exchange with it the information necessary for the correct management of the activation sequence of the axes A1, A2 upon the basis of the different treatment steps in progress. Then, through the control bus CB, it must select the device DMA1, DMA2 of the axis A1, A2, respectively, to actuate and activate the necessary blocking/unblocking sequences of the logic signals which allow the motor M and the transducer T of the selected axis A1, A2 to be put in connection with buses MB and TB.

After having ascertained that the connection of the device DMA1, DMA2 to the buses MB, TB has taken place, the actuator AMU, taking all of the operating and work parameters relative to the selected axis from an appropriate area of memory, it shall manage them, with the ways of operating relative to the type of electric motor connected at that moment, in the various regulation loops of the axis (RC, RV and RP) to bring the operation asked to it by the logic LC up to its conclusion.

It is important to underline that the architecture inside the software for controlling the actuator AMU is capable of instantly adapting the operation of the actuator to the type of electric motor M connected through the device DMA1, DMA2, which can therefore be different from axis to axis, in terms of constructive type, in terms of size and in terms of operating parameters.

The actuator AMU including in a single device the control of all of the regulation loops of the axis, makes it possible to carry out a simultaneous control in real time on the delivered torque (through the regulator RC), on the instant speed (through the regulator RV), and on the position (through the regulator RP) of the axis A1, A2, so as to quickly remove power from the motor M if the selected axis meets mechanical obstacles.

Such obstacles are indeed recognised by a sudden and unforeseen variation in the absorption of current by the motor M in combination with a slowing down of the speed and of the space covered.

Thus the costs of the electromechanical stops for the slower and more cost-effective axes can also be eliminated making the use of the architecture in question even more advantageous.

Finally, the actuator AMU carries out the supervision and management of the alarms which can intervene during the dynamic operation of the axis (like, for example, limitations in current, following errors, etc.), or which come either from the diagnostics of the device DMA1, DMA2, or from possible other auxiliary signals which are available as input and/or output in its hardware structure.

It has been seen how, based upon the classification made in the first part of the description, it is possible to provide each axis making up a piece of machinery with two applicational attributes, one of which is linked to the function of the axis in the production cycle (productive or auxiliary axis) and the other is defined upon the basis of its operating interactions with other axes (interlocked or independent axis).

Regarding this, the architecture of the integrated control system according to the present invention offers economic advantages with respect to the architectures described in the state of the art, according to the number of axes to which it can be applied.

In the following table the hypothetical conditions of applicability of an axis according to the attributes which it has with respect to the application are shown.

| | Productive axis | Auxiliary axis |
|---|---|---|
| Interlocked axis | Little | Applicability to |
| | probability of | be evaluated for |
| | applicability | each time |
| Independent axis | Good probability | High probability |
| | of applicability | of applicability |

The applicability of the integrated control system object of the invention can also be evaluated using a graphical instrument which can be readily understood.

In a Cartesian plan, as illustrated in FIG. 7, the following magnitudes are represented for each axis:
Axis X+=percentage of the number of independent axes with respect to the total number of axes;
Axis X−=percentage of the number of interlocked axes with respect to the total number of axes;
Axis Y+=percentage of the number of auxiliary axes with respect to the total number of axes;
Axis Y−=percentage of the number of productive axes with respect to the total number of axes.

FIG. 7 allows us to visually evaluate the degree of applicability of the integrated control system described in the present invention comparing the position of the rectangle RE with both sides having a width equal to 100% which represents the total of the axes used in the application under examination.

The maximum degree of applicability is obtained in the case in which all of the axes are auxiliary and independent, because the whole area of the rectangle RE, which represents the total of the axes, is contained in the quadrant X+, Y+.

Varying the percentage relationship between the two types of attributes of the axes signifies translating the position of the rectangle RE towards one of the other three quadrants, consequently decreasing the surface area contained in the quadrant X+, Y+, which represents the maximum degree of applicability of the integrated control system of the present invention.

Let us take, for example, the case of a wood polisher consisting of a motorised conveyor belt (TN), which transports the piece of wood to be treated under three treatment groups, each identified with n, consisting of a polishing band (Ln) which can be directed in space through the Cartesian axes Xn, Yn and Zn.

The directing in space of each polishing group must be carried out before starting the treatment and the treatment constraints existing between the axes consist of the need to always actuate the belts during the transit of the piece.

The following table sums up the overall situation of the application:

| | Indepen- | | | |
|---|---|---|---|---|
| Axis | dent | Interlocked | Auxiliary | Productive |
| TN | | X | | X |
| L1 | | X | | X |
| X1 | X | | X | |
| Y1 | X | | X | |
| Z1 | X | | X | |
| L2 | | X | | X |
| X2 | X | | X | |
| Y2 | X | | X | |
| Z2 | X | | X | |
| L3 | | X | | X |
| X3 | X | | X | |
| Y3 | X | | X | |
| Z3 | X | | X | |
| Percentage | 69% | 31% | 69% | 31% |
| weight | | | | |

The data shown graphically give rise to the diagram of FIG. 8, which clearly highlights that the area AR1 contained in the positive quadrant X+, Y+ is sufficiently large to guarantee in each case the applicability of the integral control system object of the invention; the area AR2 present in the quadrant X+, Y−, moreover, indicates that the number of productive axes is considerable with respect to that of the auxiliary axes and this represents a further interesting opportunity to exploit to advantageously apply the control system in question. Indeed, thanks to the characteristics of universality of the actuators AMU, it can be thought of to equip the machine with a similar number of actuators AMU to the number of productive axes and with these to govern both the productive and auxiliary axes.

In this specific case it could therefore be thought of to realise a system for controlling the axes made up of:
1 normal actuator AN dedicated to the axis TN;
3 actuators AMU which, during the productive cycle, control the axes L1, L2, L3, whereas, during the arrangement step of the machine for the treatment to be carried out, they position the respective axes X, Y, Z in the working coordinates determined by the logic LC;
12 devices DMA1, DMA2, necessary for connecting 4 axes to each actuator AMU.

Therefore, with respect to a conventional system with one actuator for each axis (like the one described in FIG. 2), the advantages are substantial because a smaller number of actuators is used and therefore there is a lower cost of the components and there is less encumbrance in the electric switchboard QC. Moreover, with the use of the actuator AMU the motion controller MC can be eliminated and the number of connection cables between the electric switchboard QC and the machine is reduced, with consequent savings in material and in cabling time, above all if the actuators AMU are installed onto the machine.

Also, with respect to the system with an intelligent actuator for each axis (described with reference to FIG. 3), the integrated control system according to the invention, besides reducing the number of actuators necessary, reducing the cabling and making it possible to assemble the actuator AMU onto the machine, drastically reduces the number of nodes connected to the field bus FB, simplifying the logic and further minimising the costs.

Moreover, if compared to the system realised with the intelligent actuator integrated with the motor (described with reference to FIG. 4), with the control system in question there is a lower cost, lower encumbrance and better heat dissipation, in that the components used decrease and the number of nodes of the field bus FB to be managed reduces, with consequent lower costs and lesser complexity.

Finally, compared with the conventional technique of “multiplexing” with normal actuators AN electromechanically switched onto many motors (as described in relation to FIG. 5), the innovative integrated control system described in the present invention allows the number of components and the cabling time necessary for realising the on-board architecture of the electric switchboard QC to be reduced.

By using the actuator AMU the motion controller MC is also eliminated and the operation of the actuator AMU can be adapted to different types of electric motor by applying for each one the appropriate regulation parameters of the regulators RC, RV, based upon the specific mechanical requirements of each single axis.

A further advantage of the integrated control system object of the invention consists of the fact that the time that the axes are out of use, during the switching from one axis to another, is reduced, with respect to the electromechanical system, since all of the parameters to be achieved are controlled directly in the actuator AMU; in practice, the integration process reduces the time of delay between the control step and the command step.

Also in this case it is possible to arrange the actuator AMU on the machine to reduce the length and costs of the connection cables between the motors and the electric switchboard and to reduce the problems of electromagnetic compatibility.

A further possibility offered by the control system according to the invention is that of being able to connect many actuator devices AMU to the same “multiplexing” devices DMA1, DMA2, in order to obtain the redundancy (regarding this see FIG. 6A for a quick comparison, where a single management and control logic LC manages many actuator devices AMU arranged in parallel).

From the description which has been made the characteristics of the integrated system for controlling the axes of industrial machinery, object of the present invention, are clear, just as the advantages are also clear.

Finally, it is also clear that numerous other variants can be brought to the integrated control system in question, without by this straying from the novelty principles inherent to the inventive idea, just as it is clear that, in the practical embodiment of the invention, the materials, the shapes and the sizes of the illustrated details can be whatever according to the requirements and they can be replaced with others which are technically equivalent.

For example, in “camming” technology, the position of each axis of the “slave” type is expressed according to the position of a reference axis known as the “master”; the “master” can be a real axis or a virtual axis, but in both cases, to make the “slave” axis follow a trajectory expressed as a function of the momentary position taken on by the “master” axis during the execution of its trajectory, it is necessary that such information is transmitted from the “master” axis to the axis or axes of the “slave” type, in real time and in a determining manner.

The determinism can be expressed to a greater or lesser degree based upon the requirements of precision and speed of application and, due to such a need, the transmission of the momentary position of the “master” axis to the “slave” axes can take place using as means of transmission one of the following communication buses arranged in the integrated control system according to the invention:
the field bus FB, if a not too precise determinism is sufficient (maximum jitter of 1 ms);
the control bus CB, if a medium determinism is sufficient (maximum jitter of 0.1 ms);
the transmission bus TB, if a high degree of determinism is necessary (maximum jitter of 0.01 ms).

In the case in which the control bus CB and the transmission bus TB are unified, it shall be necessary to adopt a configuration of connection between the actuator devices AMU as illustrated in the main diagrams shown in FIGS. 9 and 9A.

In particular, FIG. 9 illustrates a procedure for synchronising two actuator devices AMU2, AMU3, of the “slave” type, with an actuator device AMU1, of the “master” type, with a field bus FB, communication bus CB and transmission bus TB unified in the bus CTB and in which there are the control logic LC, the interfaces DMA1, DMA2 and the motors and transducers M1, T1, M2, T2, respectively belonging to the interface DMA1 and to the interface DMA2.

FIG. 9A then shows a procedure for synchronising three actuator devices in a “master/slave” cascade, of which one (AMU1) is of the “master” type, one (AMU3) is of the “slave” type and one (AMU2) is “slave/master” AMU1, with a field bus FB, communication bus CB and transmission bus TB unified in the bus CTB and in which there are the control logic LC, the interfaces DMA1, DMA2 and the motors and transducers M1, T1, M2, T2, respectively belonging to the interfaces DMA1 and DMA2.

1. Integrated system for controlling the axes (A1, A2) of industrial machinery, said axes (A1, A2) being actuated by actuator means (AN, AZ, AZ1, AZ2), which apply a force so as to determine a displacement in space, with at least one motor (M), suitable for giving motion commands to at least one of said axes (A1, A2), also applied to said axes (A1, A2), characterised in that each motor (M) is connected to at least one interface (DMA1, DMA2) for connection to at least one actuator device (AMU), said interface (DMA1, DMA2) foreseeing means suitable for supplying or not supplying energy to the motor (M) according to that which is requested by said actuator device (AMU), said actuator device (AMU) also foreseeing means for the management and selection (LSA) of each axis (A1, A2), through said interface (DMA1, DMA2).

2. Integrated control system according to claim 1, characterised in that said management and selection means (LSA) send and exchange with said axes (A1, A2) and with at least one control logic (LC) of the entire management, measurement and supply information system by means of at least one communication bus (MB, CB, TB, FB).

3. Integrated control system according to claim 2, characterised in that said interface (DMA1, DMA2) communicates with said actuator device (AMU) by means of functional coordination buses (CB), transmission buses (TB) for the information coming from transducers (T), suitable for converting physical amplitudes into electrical signals, and supply buses (MB), suitable for supplying energy to said motor (M), said communication buses (CB, TB, FB, MB) being foreseen to conduct information signals and/or to provide a supply to the system.

4. Integrated control system according to claim 1, characterised in that said actuator device (AMU) is an intelligent electrical actuator device, suitable for automatically configuring its own way of operating in relation to the type and size of the motor (M) connected to said specific interface (DMA1, DMA2).

5. Integrated control system according to claim 1, characterised in that said actuator device (AMU) can integrate switching means managed through a “multiplexing” technique for commanding many motors (M).

6. Integrated control system according to claim 2, characterised in that said communication buses (FB, CB, TB, MB) are managed by said multiaxis actuator device (AMU), which controls the selected motor (M) in current, speed and position, through a plurality of regulators (RP, RV, RC).

7. Integrated control system according to claim 1, characterised in that said actuator device (AMU) can be attached to the outside or on the machine, near to the axes (A1, A2) which it has to govern.

8. Integrated control system according to claim 1, characterised in that said actuator device (AMU) carries out the supervision and management of the alarms which can intervene during the dynamic operation of the axis (A1, A2), or which come both from the diagnostics of said interface (DMA1, DMA2) and from possible other auxiliary signals available as input and/or output in its hardware structure.

9. Integrated control system according to claim 1, characterised in that, if the number of productive axes is substantial with respect to that of the auxiliary axes, it is possible to equip a piece of machinery with a number of said actuator devices (AMU) which is comparable to the number of productive axes, in order to govern both the productive and auxiliary axes with them.

10. Integrated control system according to claim 1, characterised in that it is possible to synchronise and interpolate the trajectories of many productive axes, through an integrated management in the actuator devices (AMU1, AMU2, AZU3) of a technique of synchronisation of position between an axis of the “master” type and an axis of the “slave” type and by appropriately using at least one of said communication buses (FB, CB, TB), to transmit the position of said axis of the “master” type in a determinate manner to said actuator device (AMU2, AMU3) which manages said axis of the “slave” type.

11. Integrated system for controlling the axes (A1, A2) of industrial machinery as substantially described and illustrated in the attached drawings and for the specified purposes.
